(19) United States
(12) Patent Application Publication
(10) Pub. No.: US 2006/0018814 A1
(43) Pub. Date: Jan. 26, 2006

(54) Processing method of gas and processing apparatus of gas

(76) Inventors: Takashi Shimada, Kanagawa (JP); Noboru Takemasa, Kanagawa (JP); Koshi Ochi, Kanagawa (JP); Hiroshi Waki, Kanagawa (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/174,519

(22) Filed: Jul. 6, 2005

(30) Foreign Application Priority Data
Jul. 7, 2004 (JP) 2004-200362

(51) Int. Cl. B01J 8/00; B01J 8/04

(52) U.S. Cl. 423/239.1; 422/190; 422/211

(57) ABSTRACT

A processing method of gas containing water and nitrogen oxides, which comprises the steps of bringing the gas into contact with a water adsorbent to remove water contained in the gas, and then, bringing the gas into contact with a palladium catalyst to remove nitrogen oxides contained in the gas. A processing apparatus of gas containing water and nitrogen oxides, which comprises an inlet for the gas containing water and nitrogen oxides, a filling part for a water adsorbent, a filling part for a palladium catalyst and an outlet for the processed gas, wherein the filling part for a water adsorbent is deployed adjacent to the inlet, and the filling part for a palladium catalyst is deployed adjacent to the outlet. A processing method and a processing apparatus for easily removing nitrogen oxides contained in gas such as air with superior processing capability and removing efficiency without employing processing unit having the structure of large-scale or complicated, without unintentionally desorbing the nitrogen oxides once adsorbed is obtained.

### TECHNICAL FIELD

The present invention relates to a processing method of gas and a processing apparatus of gas. Particularly, the present invention relates to a processing method of gas and a processing apparatus of gas both efficiently remove nitrogen oxides contained together with moisture in the gas such as air.

### BACKGROUND ART

Conventionally, analyses of hazardous component of nitrogen oxides contained in exhaust gas supplying the exhaust gas discharged from automobiles driven with various travel modes into a gas measuring instrument through chassis dynamometer are frequently tried. In an occasion of measuring concentration of nitrogen oxides, a zero calibration gas without containing nitrogen oxides at all is necessary and as a supplying means for such a zero calibration gas, a cylinder filled with high pressure gas may be employed, however, there was inconvenience of being uneconomical as for employing expensive cylinders because the use amount of the high pressure gas was great. Therefore a processing method of gas removing nitrogen oxides in air with the use of adsorbent, catalyst or a cleaning agent for air as the material has been developed.

Conventionally, there are a wet process, a non-catalytic reduction process, a catalytic reduction process, an adsorption process and so on practical as a processing method of gas removing nitrogen oxides from the gas containing them, and for the purpose of the above approach, the catalytic reduction process or the adsorption process was popularly taken advantage of. The catalytic reduction process generally removes the nitrogen oxides by adding reductive gas such as ammonia or the like to the gas containing nitrogen oxides, bringing them into contact with a catalyst comprising metal or metallic compound under heating and by reductively decomposing the nitrogen oxides into nitrogen and water. The adsorption process removes nitrogen oxides in the gas by physically or chemically bringing the gas into contact with an adsorbent such as activated carbon, zeolite and so on or a noble metal oxide catalyst such as palladium oxide, etc.

For example, Japanese Unexamined Patent Application Laid-Open No. Hei 5-168927 discloses a catalytic activity component comprising palladium, alkaline earth metal oxide, lanthanum oxide, cerium oxide and zirconium oxide; and it also discloses a catalyst formed by supporting a mixture comprising activated alumina on a carrier having monolith structure. Japanese Unexamined Patent Application Laid-Open No. Hei 8-168648 discloses a noble metal oxide catalyst supporting palladium oxide, silver oxide or so on an inorganic porous carrier. Japanese Unexamined Patent Application Laid-Open No. Hei 11-76819 discloses a catalyst comprising rhodium and palladium, and Japanese Unexamined Patent Application Laid-Open No. 2001-149758 discloses a catalyst of any metal selected from rhodium, palladium, rhodium oxide, palladium oxide and those mixture and/or a catalyst formed by supporting it on the compound zeolite carrier.

However, the removing process of nitrogen oxides in accordance with the catalytic reduction method had disadvantages such that when the amount of reductive gas such as ammonia or so that will be added is small, the nitrogen oxides cannot be removed completely because decomposition of the nitrogen oxides becomes not enough, and that when the amount of reductive gas is large, harmful gas such as ammonia is discharged and a system to control flow amount of the reductive gas become necessary, making the processing unit large-scale and complicated, resultantly troublesome in operation.

Further, the removing process of nitrogen oxides in accordance with the adsorption process had problems such that a processing capability (a quantity of nitrogen oxides removed per adsorbent) and a removing efficiency in the case of removing the nitrogen oxides of low concentration such as air were small, and that there was an anxiety that the nitrogen oxides once adsorbed in removal might desorbs depending on the process condition.

### DISCLOSURE OF THE INVENTION

Therefore, an object of the present invention is to provide a processing method and a processing apparatus for easily removing nitrogen oxides contained in a gas such as air with superior processing capability and removing efficiency without employing processing unit having the structure of large-scale or complicated, without unintentionally desorbing the nitrogen oxides once adsorbed.

As a result of intensive extensive research and investigation made by the present inventors in order to achieve the object, it has been found that preceding removal of water contained in the gas to be processed before removing nitrogen oxides by the adsorbing method with the use of palladium catalyst remarkably improves a processing capability about the nitrogen oxides of the palladium catalyst (removing amount of nitrogen oxides per unit amount of the palladium catalyst) to realize a removing efficiency about the nitrogen oxides of 1 ppb or smaller and that the unintentional desorption of the nitrogen oxides never generates and the present invention was completed.

Namely, the present invention provides a processing method of gas containing water and nitrogen oxides, which comprises the steps of bringing the gas into contact with a water adsorbent to remove water contained in the gas, and then, bringing the gas into contact with a palladium catalyst to remove nitrogen oxides contained in the gas.

Further, the present invention provides a processing apparatus of gas containing water and nitrogen oxides, which comprises an inlet for the gas containing water and nitrogen oxides, a filling part of a water adsorbent, a filling part of a palladium catalyst and an outlet of the processed gas, wherein the filling part of a water adsorbent is deployed adjacent to the inlet, and the filling part of a palladium catalyst is deployed adjacent to the outlet. The gas containing water and nitrogen oxides to be processed is predetermined to flow through the apparatus in this order.

### BRIEF DESCRIPTION OF THE DRAWINGS

FIG. 1 is a vertical cross-sectional view showing an embodiment of a processing apparatus of gas in the present invention;

FIG. 2 is a vertical cross-sectional view showing another embodiment of a processing apparatus of gas in the present invention aside from FIG. 1: and

FIG. 3 is a block diagram showing an embodiment wherein a processing apparatus in the present invention and another processing apparatus are combined to use.

### THE PREFERRED EMBODIMENT TO CARRY OUT THE INVENTION

The present invention is applied to a processing method and a processing apparatus for removing water and nitrogen oxides from the gas containing these, for example, for purification of air, purification of inert gas, purification of exhaust gas discharged from semiconductor manufacturing apparatus, etc.

Further in the present invention, it is possible to remove not only water or nitrogen oxides but also carbon dioxide by appropriately selecting the water adsorbent. Moreover, further attaching a filling part of a noble metal catalyst and heater for heating the filling part at an up-stream of the processing apparatus enables to convert an inflammable gas such as hydrogen, carbon monoxide, methane or so contained in the gas to be processed into water and carbon dioxide, thereby also enables to remove the resultant water and carbon dioxide by means of processing method and processing apparatus of the present invention.

Typical examples of the water adsorbent employable in the present invention include synthetic zeolite, natural zeolite, alumina, silica alumina, etc. Among these, it is preferable to employ synthetic zeolite being superior in adsorption capability about water. When synthetic zeolite is employed as the adsorbent, any kind may be employable without being particularly restricted and, for example, any commercially available synthetic zeolite with pore diameters of 3 to 15 Å equivalent in the market may be employable.

Further, typical examples of palladium catalyst employable in the present invention include not only palladium oxide but also palladium metal or palladium compound such as palladium chloride, palladium carbonate, etc. However, when palladium metal or palladium compound except palladium oxide is employed as the palladium catalyst, it is necessary to heat-treat the catalyst in advance. These catalysts are usually used in a supported form onto an inorganic carrier such as alumina, silica, zirconia, titania, silica alumina, activated carbon, diatom earth, etc. Further, although the commercially available palladium catalysts in the market include those which contain metals such as chromium, titanium and so on or metal compound other than palladium, those may be also employed in the present invention.

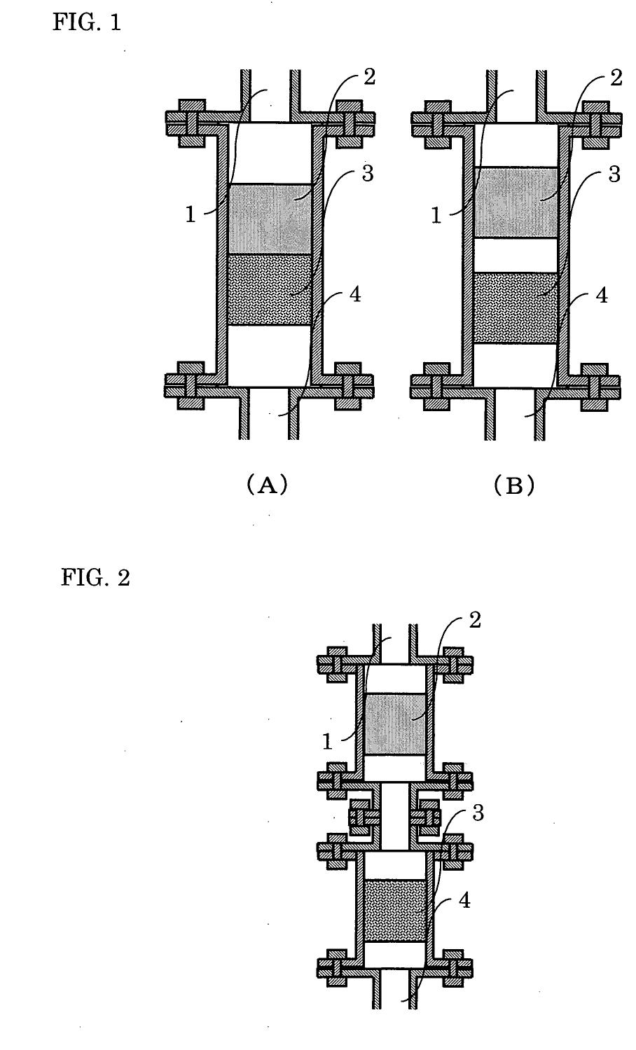

The processing method of gas and the processing apparatus in the present invention will be described in further detail with reference to FIGS. 1 to 3, which does not limit the scope of the invention.

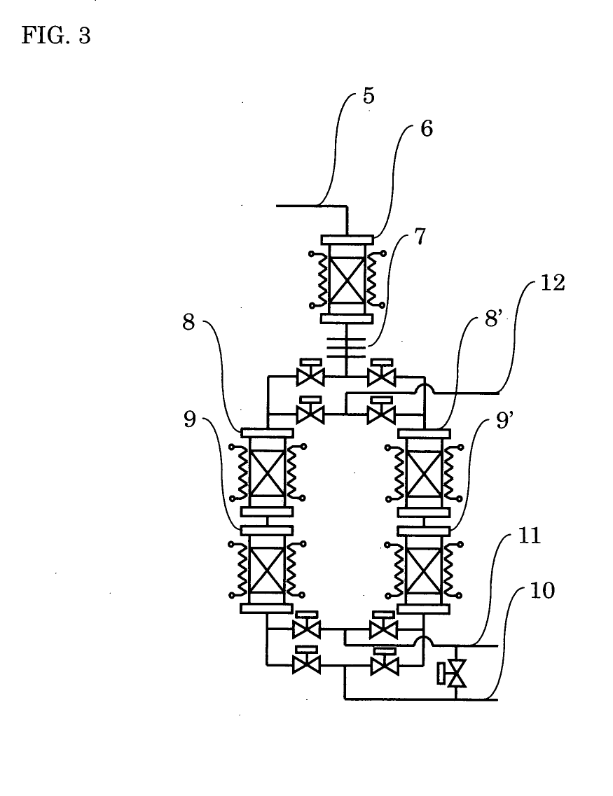

FIGS. 1 and 2 are vertical cross-sectional views showing embodiments of processing apparatuses of gas in the present invention; and FIG. 3 is a block diagram showing an embodiment wherein a processing apparatus in the present invention and another processing apparatus are combined to use.

As shown in FIGS. 1 and 2, a processing apparatus of gas in accordance with the present invention comprises an inlet 1 for the gas containing water and nitrogen oxides, a filling part 2 for a water adsorbent, a filling part 3 for a palladium catalyst and an outlet 4 for the processed gas, wherein the filling part 2 of a water adsorbent is deployed adjacent to the inlet 1, and the filling part 3 for a palladium catalyst is deployed adjacent to the outlet 4. The gas containing water and nitrogen oxides to be processed is predetermined to flow through the apparatus in this order. Additionally, it is preferable for the processing apparatus of gas in the present invention that it further comprises heater for enabling to reactivate the water adsorbent after usage and the palladium catalyst after usage.

In the present invention, the water adsorbent and the palladium catalyst may be filled in one processing column as shown in FIG. 1, or may be filled in each different processing column as shown in FIG. 2. Although the filling amount and the filling length of the water adsorbent and the palladium catalyst are impossible to be specified unconditionally because they are different depending on the concentration of the water or the nitrogen oxides which is contained in the gas to be processed or on its flow rate, the each practical filling lengths are usually 5 to 150 cm respectively. When the filling length is shorter than 5 cm, an anxiety that the removing efficiency of water or nitrogen oxides decreases will appear, and when it is longer than 150 cm, an anxiety that the pressure loss becomes too large will appear.

In FIG. 1 (A), it is preferable that a disc shape separation plate made of stainless steel, titanium or ceramics and having many pinholes or pores is equipped at the boundary portion between the filling part 2 for the water adsorbent and the filling part 3 for the palladium catalyst in order to prevent inconvenience that the water adsorbent and the palladium catalyst mix each other without disturbing the gas to be processed from flowing through.

The gas to be processed in the present invention usually contains water in an amount of 100 ppm or more together with nitrogen oxides such as N₂O, NO, N₂O₃, NO₂, N₂O₅, etc., however, a gas without containing water may be processed similarly.

In the occasion of processing the gas containing water and nitrogen oxides, it is not necessary to heat the water adsorbent and the palladium catalyst, and it is usually possible to process at room temperature or around the room temperature (about 0 to 100° C.). Regarding with the pressure in the processing column filling the water adsorbent and the palladium catalyst, although it is usually an ordinary pressure, the operation may be carried out under the reduced pressure of 10 kPa (absolute pressure) or under the compressed pressure of 1 MPa (absolute pressure).

In the present invention, after the water adsorbent processed the water contained in the gas to be processed to 100 ppm or less, preferably to 10 ppm or less, then, the palladium catalyst removes the nitrogen oxides contained in the gas to be processed. When the water is not removed to the concentration of 100 ppm or less, there comes an anxiety that the processing capability about nitrogen oxides by the palladium catalyst decreases. In the case where synthetic zeolite is employed as the water adsorbent, although the water adsorption capability of synthetic zeolite (absorbed amount of water per unit amount of synthetic zeolite) is usually about 100 L/L agent, the nitrogen oxides adsorption capability of palladium catalyst (absorbed amount of nitrogen oxides per unit amount of palladium catalyst) under the existence of water is about 0.001 L/L agent. However, previously removing water in the present invention enables to improve the adsorption capability (processing capability) about nitrogen oxides by the palladium catalyst 100 times or more and to extend the lifetime of the palladium catalyst remarkably.

In the present invention, it is possible to easily reactivate the water adsorbent and the palladium catalyst. In order to reactivate, heating the water adsorbent and the palladium catalyst, and simultaneously supplying inert gas or so, preferably supplying a part of the processed gas, water is desorbed from the water adsorbent and the nitrogen oxides are desorbed from the palladium catalyst. The contact temperature of the water adsorbent and the palladium catalyst in an occasion of their reactivation are usually 150 to 500° C. and preferably 200 to 400° C. When the contact temperature is lower than 150° C., an anxiety of insufficient reactivation appears and when the contact temperature is higher than 500° C., an anxiety that the load of the processing column become extravagant appears. A necessary pressure for the reactivation is usually an ordinary pressure; however, it is possible to reactivate under a reduced pressure such as 10 KPa (absolute pressure) or under a compressed pressure such as 1 MPa (absolute pressure).

In the present invention, it is preferable to deploy at least 2 lines each comprising the processing apparatus of gas in accordance with the present invention (filling column for the water adsorbent and the palladium catalyst, or filling column for the water adsorbent and filling column for the palladium catalyst) in order to continuously process the gas containing water and nitrogen oxides. The above deployment of the processing apparatuses enables to remove water and nitrogen oxides from the gas to be processed and simultaneously to reactivate the water adsorbent after usage and the palladium catalyst after usage while changing the lines in turn; thereby further enables to continuously remove water and nitrogen oxides from the gas containing water and nitrogen oxides.

Further, as shown in FIG. 3, the processing apparatus of gas (filling columns 8, 8′ for the water adsorbent and filling columns 9, 9′ for the palladium catalyst) in the present invention may be connected with other device, for example, with filling column 6 for noble metal catalyst equipped with a heater, in its practical use. The above practical arrangement enables to remove inflammable gas such as hydrogen, carbon monoxide, methane, etc., or carbon dioxide, water and nitrogen oxides from the gas containing these. Namely, hydrogen, carbon monoxide and methane each is converted into water, carbon dioxide and water & carbon dioxide respectively in the filling part for heated noble metal catalyst; water and carbon dioxide are removed by adsorption in the filling part for water adsorbent (synthetic zeolite); and nitrogen oxides are removed by adsorption in the filling part for the palladium catalyst.

Additionally in FIG. 3, reference numeral 5 represents an introduction pipe for the gas containing water and nitrogen oxides, reference numeral 6 represents a filling column for the noble metal catalyst, reference numeral 7 represents a cooler, reference numeral 10 represents a drawing pipe for the processed gas, reference numeral 11 represents an introduction pipe for the reactivated gas, and reference numeral 12 represents an exhaust pipe for the reactivated gas.

### EXAMPLES

In the following examples are described several preferred embodiments to concretely illustrate the invention; however, it is to be understood that the invention is not intended to be limited to the specific embodiments.

### Example 1

(Preparation of Processing Apparatus)

A processing apparatus made of stainless-steel as shown in FIG. 1 (A) was prepared by filling commercially available synthetic zeolite (pore size: 5 Å equivalent) and commercially available palladium catalyst (adhering 0.3% by weight of palladium onto alumina) into a processing column having an inside diameter of 16 mm and a height of 600 mm in a manner that each filling length became 400 mm and 150 mm respectively. Further, a heater was mounted to side surface of the processing column.

(Purification Test of Air)

Elevating the inside temperature of the processing column to 350° C., and flowing nitrogen gas through the processing column with flow rate of 300 ml/min for 3 hours, the synthetic zeolite and the palladium catalyst were heat-treated and then, the processing column was cooled down to room temperature.

Subsequently, supplying air containing 2000 ppm of water and 1 ppm of nitrogen monoxide into the processing apparatus with flow rate of 1000 ml/min (at the temperature of 25° C.), simultaneously sampling gas at the outlet of the processing column, and the time before detecting nitrogen monoxide was measured by means of NOx instrument (lower limit of detection: 0.5 ppb). Then, a processing capability of palladium catalyst about the nitrogen oxides (absorbed amount (L) of nitrogen oxides per 1 L of palladium catalyst) was calculated. The results are shown in Table 1.

(Reactivation of Water Adsorbent and Palladium Catalyst)

Heating the water adsorbent and the palladium catalyst both after usage up to 350° C., and simultaneously supplying purified air with a flow rate of 300 ml/min (at the temperature of 25° C.) for 3 hours, reactivation was carried out by desorbing water from the water adsorbent and by desorbing nitrogen oxides from the palladium catalyst.

(Re-Purification Test of Air)

Supplying air containing 2000 ppm of water and 1 ppm of nitroge oxide again into the processing apparatus with flow rate of 1000 ml/min (at the temperature of 25° C.), simultaneously sampling gas at the outlet of the processing column, and the time before detecting nitrogen monoxide was measured by means of NOx instrument (lower limit of detection: 0.5 ppb). Then, a processing capability of palladium catalyst about the nitrogen oxides (absorbed amount (L) of nitrogen oxides per 1 L of palladium catalyst) was calculated. The results are shown in Table 1.

### Examples 2 and 3

The purification test of air was conducted in the same manner as Example 1 except that the concentration of the nitrogen oxides was changed to 0.5 ppm and 5 ppm respectively. The results are shown in Table 1.

### Examples 4 and 5

The purification test of air was conducted in the same manner as Example 1 except that the concentration of water was changed to 500 ppm and 50 ppm respectively. The results are shown in Table 1.

### Example 6

The purification test of air was conducted in the same manner as Example 1 except that the nitrogen oxides was replaced to NO₂. The results are shown in Table 1.

### Example 7

The purification test of air was conducted in the same manner as Example 1 except that the gas to be processed was replaced to air containing 2000 ppm of water and 1 ppm of nitrogen monoxide. The results are shown in Table 1.

### Example 8

(Preparation of Processing Apparatus)

A processing apparatus for converting an inflammable gas into carbon dioxide and water was prepared by filling commercially available noble metal catalyst (adhering 0.3% by weight of palladium onto alumina) in the market into a processing column made of stainless-steel having an inside diameter of 16 mm and a height of 100 mm and also having a heater in a manner that a filling length became 50 mm. Then, a processing apparatus similarly as that in Example 1 was connected downstream of the above processing apparatus via a cooler.

(Purification Test of Air)

Elevating the inside temperature of each processing column to 350° C., and flowing nitrogen gas through the processing column with flow rate of 300 ml/min for 3 hours, the noble metal catalyst, synthetic zeolite and the palladium catalyst were heat-treated, and then, only the processing column in the present invention was cooled down to room temperature.

Supplying air containing 1 ppm of hydrogen, 1 ppm of carbon monoxide, 1 ppm of methane, 2000 ppm of water and 1 ppm of nitrogen monoxide into the processing apparatus with a flow rate of 1000 ml/min (at the temperature of 25° C.), simultaneously sampling gas at the outlet of the processing column, and the presence or absence of these impurity gases was measured. As a result, a processing capability of palladium catalyst about the nitrogen oxides (absorbed amount (L) of nitrogen oxides per 1 L of palladium catalyst) was calculated from the time that before nitrogen monoxide among these impurity gases was initially detected. The results are shown in Table 1.

### Comparative Example 1

A processing apparatus was prepared in the same manner as Example 1 except that synthetic zeolite was not filled into the processing column.

Then, purification test of air was conducted in the same manner as Example 1 except the use of this processing apparatus. The results are shown in Table 1.

### Comparative Examples 2 and 3

The purification test of air was conducted in the same manner as Comparative Example 1 except that the concentration of water was changed to 500 ppm and 50 ppm respectively. The results are shown in Table 1.

TABLE 1

| | Contents in | | | | | | Processing |
|---|---|---|---|---|---|---|---|
| | Processing | Gas to be | Impurities | | | | capability |
| | column | Processed | H₂O (ppm) | NOx | (ppm) | Others | (L/L Agent) |
| Ex. 1 | Zeolite + Pd catalyst | Air | 2000 | NO | 1 | | 0.23 |
| (Reactivated) | Zeolite + Pd catalyst | Air | 2000 | NO | 1 | | 0.22 |
| Ex. 2 | Zeolite + Pd catalyst | Air | 2000 | NO | 0.5 | | 0.19 |
| Ex. 3 | Zeolite + Pd catalyst | Air | 2000 | NO | 5 | | 0.24 |
| Ex. 4 | Zeolite + Pd catalyst | Air | 500 | NO | 1 | | 0.22 |
| Ex. 5 | Zeolite + Pd catalyst | Air | 50 | NO | 1 | | 0.22 |
| Ex. 6 | Zeolite + Pd catalyst | Air | 2000 | NO₂ | 1 | | 0.38 |
| Ex. 7 | Zeolite + Pd catalyst | Helium | 2000 | NO | 1 | | 0.23 |
| Ex. 8 | Zeolite + Pd catalyst | Air | 2000 | NO | 1 | H₂, CO, CH₄ | 0.35 |
| Co. Ex. 1 | Pd catalyst | Air | 2000 | NO | 1 | | 0.001 |
| Co. Ex. 2 | Pd catalyst | Air | 500 | NO | 1 | | 0.006 |
| Co. Ex. 3 | Pd catalyst | Air | 50 | NO | 1 | | 0.18 |

As apparent from Table 1, Examples with the use of the water adsorbent, especially in the case where moisture content as impurity is great, revealed remarkably more excellent processing capability about NOx than the Comparative Example without using the water adsorbent.

As described above, both the processing method of gas and the processing apparatus of gas in the present invention particularly reveal effect in removal of nitrogen oxides from the air containing relatively large amount of water, i.e., in purification of air. Further, the gas to be processed is not restricted to air but may be any gas containing water (100 ppm or more), and great effect in removal of nitrogen oxides from an inert gas such as helium and so on, i.e., purification of inert gas, or removal of nitrogen oxides from discharged gas from semiconductor manufacturing process, etc., will be expected.

### INDUSTRIAL APPLICABILITY

The processing method and the processing apparatus in accordance with the present invention enable to easily remove nitrogen oxides contained in a gas such as air with superior processing capability and removing efficiency without employing processing unit having the structure of large-scale or complicated, without unintentionally desorbing the nitrogen oxides once adsorbed. Moreover, a remarkable improvement in the processing capability about nitrogen oxides, which was extremely small in the past enabled to reactivate palladium catalyst after usage and to use repeatedly, thereby making removal of nitrogen oxides efficient.

While there has been shown and described what are at present considered the preferred embodiments of the invention, it will be obvious to those skilled in the art that various changes and modification may be made therein without departing from the scope of the invention defined by the appended claims.

What is claimed is:

1. A processing method of gas containing water and nitrogen oxides, which comprises the steps of bringing the gas into contact with a water adsorbent to remove water contained in the gas, and then, bringing the gas into contact with a palladium catalyst to remove nitrogen oxides contained in the gas.

2. The processing method of gas according to claim 1, wherein said gas is air.

3. The processing method of gas according to claim 1, wherein a water content in said gas is at least 100 ppm.

4. The processing method of gas according to claim 1, wherein said water adsorbent is a synthesized zeolite.

5. The processing method of gas according to claim 1, which further comprises the steps of heating the water adsorbent after usage and the palladium catalyst after usage, simultaneously flowing the processed gas partially through the adsorbent and the catalyst to reactivate the adsorbent and the catalyst.

6. A processing apparatus of gas containing water and nitrogen oxides, which comprises an inlet for the gas containing water and nitrogen oxides, a filling part for a water adsorbent, a filling part for a palladium catalyst and an outlet for the processed gas, wherein the filling part for a water adsorbent is deployed adjacent to the inlet, and the filling part for a palladium catalyst is deployed adjacent to the outlet.
